(19) United States
(12) Patent Application Publication
(10) Pub. No.: US 2026/0225443 A1
(43) Pub. Date: Aug. 6, 2026

(54) VEHICLE, SYSTEM AND METHOD OF CONTROLLING THE VEHICLE

(71) Applicant: BOMBARDIER RECREATIONAL PRODUCTS INC., Valcourt (CA)

(72) Inventors: Nicolas LABERGE, Magog (CA); Erik Carl Gustav EVERS, Bromont (CA); Andre COTE, Hatley (CA)

(21) Appl. No.: 19/150,257

(22) PCT Filed: Jan. 26, 2024
(86) PCT No.: PCT/IB2024/050757

§ 371 Date: Jul. 23, 2025

Related U.S. Application Data
(60) Provisional application No. 63/482,438, filed on Jan. 31, 2023.

(51) Int. Cl. B60K 35/22; B60K 35/10; B60K 35/29

(52) U.S. Cl. CPC B60K 35/22; B60K 35/10; B60K 35/29; B60K 2360/115; B60K 2360/566; B60K 2360/573

(57) ABSTRACT

Vehicles, systems, and methods for controlling vehicle functions are disclosed. The vehicle has a mounting bracket configured for holding a user device. The vehicle has a vehicle control system configured to in response to being communicatively coupled with the user device, trigger display of a second element on the device screen indicative of a second vehicle function and receive user input from the user device for controlling the second vehicle function. The method includes triggering display of a first layout on the vehicle screen, the first layout including a first element indicative of a first vehicle function, triggering display of a second layout on the device screen in addition to the first layout on the vehicle screen, the second layout including a second element indicative of a second vehicle function, receiving a user input from the user device, and control the second vehicle function based on the user input.

### CROSS-REFERENCE

The present application claims priority from a U.S. provisional application number 63/482,438, entitled “VEHICLE, SYSTEM AND METHOD OF CONTROLLING THE VEHICLE”, filed on Jan. 31, 2023, and the content of which is incorporated herein by reference in its entirety.

### FIELD OF TECHNOLOGY

The present technology relates to vehicles, more specifically to systems and methods of controlling the vehicle.

### BACKGROUND

Vehicles often include display devices therein which display various types of information for a user of a vehicle. These display devices are often disposed in a middle portion of an instrument panel of the vehicle. They are also often an integral part of an operating unit of the vehicle.

In smaller vehicles in particular, such display devices generally tend to have a small-sized display screen due to dimensional restrictions within the cabin. Accordingly, displaying a great amount of information on such display devices results in the display size of the information being small, and hence difficult to view. Furthermore, the larger the display device, the more it is costly, which will result in a more expensive vehicle.

There thus remains a desire for ameliorating display interfaces for mitigating at least some of the above-described disadvantages.

### SUMMARY

It is an object of the present technology to ameliorate at least some of the inconveniences present in the prior art.

Modern vehicles often allow a user's device to connect to the vehicle via systems such as Apple's CarPlay™ and Google's Android Auto™, for example. However, developers of the present technology have realized that none of these systems make use of the vehicle's device screen itself. It would be advantageous, in particular in a low-cost vehicle, to provide a system that makes use of the user's personal user device in addition to or alternatively to a vehicle screen to ameliorate user experience during operation of the vehicle.

In a first broad aspect of the present technology, there is provided a vehicle. The vehicle comprises a frame, a vehicle body formed at least in part by the frame, a passenger compartment defined at least in part by the vehicle body, a motor supported by the frame, a plurality of wheels rotatively connected to the frame and being operatively connected to the motor, at least one seat disposed in the passenger compartment, a vehicle screen disposed in the passenger compartment. The vehicle comprises a mounting bracket disposed in proximity to the vehicle screen. The mounting bracket is configured for holding a user device. The user device includes a device screen. The vehicle comprises a vehicle control system communicatively coupled with the vehicle screen. The vehicle control system is configured to trigger display of a first element on the vehicle screen indicative of a first vehicle function, and in response to being communicatively coupled with the user device, (i) trigger display of a second element on the device screen indicative of a second vehicle function and (ii) receive user input from the user device for controlling the second vehicle function.

In some embodiments of the vehicle, the mounting bracket is disposed in proximity to the vehicle screen so that the device screen is adjacent to the vehicle screen when the user device is held by the mounting bracket.

In some embodiments of the vehicle, the first vehicle function is different from the second vehicle function.

In some embodiments of the vehicle, the vehicle control system is further configured to trigger display of a third element on the vehicle screen indicative of the second vehicle function.

In some embodiments of the vehicle, in response to being communicatively coupled to the user device, the vehicle control system is configured to trigger display of both the second element on the device screen and the third element on the vehicle screen.

In some embodiments of the vehicle, in response to being communicatively coupled to the user device, the vehicle control system is configured to trigger display of the second element on the device screen instead of displaying the third element on the vehicle screen.

In some embodiments of the vehicle, the vehicle control system is configured to trigger display of the second element and receive the user input during operation of the vehicle.

In some embodiments of the vehicle, the first vehicle function is a plurality of first vehicle functions comprising at least one of: headlight angle, seat heating, steering wheel heating, Heating Ventilation Air Conditioning (HVAC) control, vehicle speed, digital camera feed, driving mode, charge status, charge time, cruise control, turn signal, and tyre pressure.

In some embodiments of the vehicle, the second vehicle function is a plurality of second vehicle functions comprising at least one of: seat heating, steering wheel heating, Heating Ventilation Air Conditioning (HVAC) control, door locking, door unlocking, window defrosting, navigation, and media player.

In some embodiments of the vehicle, the user device is a smartphone.

In some embodiments of the vehicle, the user device is a tablet.

In some embodiments of the vehicle, the device screen includes a touch-screen configured to capture the user input.

In some embodiments of the vehicle, the vehicle control system is configured to communicatively couple with the user device by at least one of a wired connection and a wireless connection.

In a second broad aspect of the present technology, there is provided a vehicle. The vehicle comprises a frame; a vehicle body formed at least in part by the frame; a passenger compartment defined at least in part by the vehicle body; a motor supported by the frame; a plurality of wheels rotatively connected to the frame, the plurality of wheels being operatively connected to the motor; at least one seat disposed in the passenger compartment; a user interface disposed in the passenger compartment, the user interface configured to receive a first user input. The vehicle comprises a mounting bracket disposed in the passenger compartment. The mounting bracket is configured to hold a user device and the user device has a device screen. The vehicle comprises a vehicle control system configured to in response to being communicatively coupled with the user device, trigger display of an element indicative of a vehicle function on the device screen and receive second user input for controlling the vehicle function from the user device. The vehicle function is uniquely controllable in response to receiving by the vehicle control system the second user input from the user device.

In some embodiments of the vehicle, the vehicle function is not controllable via the user interface.

In some embodiments of the vehicle, the vehicle function is a plurality of vehicle functions comprising at least one of: seat heating, steering wheel heating, Heating Ventilation Air Conditioning (HVAC) control, door locking, door unlocking, window defrosting, navigation, and media player.

In some embodiments of the vehicle, the vehicle control system is configured to trigger display of the element and receive the user input during operation of the vehicle.

In some embodiments of the vehicle, the user interface is a touch-screenless interface.

In some embodiments of the vehicle, the user interface comprises at least one of: an acceleration pedal, a brake pedal, a steering wheel, a headliner console, a center console, and a key fob.

In a third broad aspect of the present technology, there is provided a system. The system comprises a user device including a device screen and a vehicle. The vehicle comprises a frame; a vehicle body formed at least in part by the frame; a passenger compartment defined at least in part by the vehicle body; a motor supported by the frame; a plurality of wheels rotatively connected to the frame, the plurality of wheels being operatively connected to the motor; at least one seat disposed in the passenger compartment; a vehicle screen disposed in the passenger compartment. The vehicle comprises a mounting bracket disposed in the passenger compartment in proximity to the vehicle screen. The mounting bracket is configured for holding the user device. The vehicle comprises a vehicle control system communicatively coupled with the vehicle screen and the user device. The vehicle control system is configured to trigger display of a first element on the vehicle screen indicative of a first vehicle function, trigger display of a second element on the device screen indicative of a second vehicle function, and receive user input from the user device for controlling the second vehicle function.

In some embodiments of the system, the mounting bracket is disposed in proximity to the vehicle screen so that the device screen is adjacent to the vehicle screen when the user device is held by the mounting bracket.

In some embodiments of the system, the first vehicle function is different from the second vehicle function.

In some embodiments of the system, the vehicle control system is configured to trigger display of a third element on the vehicle screen indicative of the second vehicle function in addition to the second element on the device screen.

In some embodiments of the system, the user device is a smartphone.

In some embodiments of the system, the user device is a tablet.

In some embodiments of the system, the device screen includes a touch-screen configured to capture the user input.

In some embodiments of the system, the vehicle is an electrically powered vehicle.

In a fourth broad aspect of the present technology, there is provided a system. The system comprises a user device including a device screen and a vehicle. The vehicle includes a frame; a vehicle body formed at least in part by the frame; a passenger compartment defined at least in part by the vehicle body; a motor supported by the frame; a plurality of wheels rotatively connected to the frame, the plurality of wheels being operatively connected to the motor; at least one seat disposed in the passenger compartment. The vehicle includes a user interface disposed in the passenger compartment, and the user interface is configured to receive a first user input. The vehicle includes a mounting bracket disposed in the passenger compartment. The mounting bracket is configured to hold the user device. The vehicle includes a vehicle control system configured to trigger display of an element indicative of a vehicle function on the device screen and receive second user input for controlling the vehicle function from the user device. The vehicle function is uniquely controllable in response to receiving by the vehicle control system the second user input from the user device.

In some embodiments of the system, the vehicle function is not controllable via the user interface.

In some embodiments of the system, the user device is a smartphone.

In some embodiments of the system, the user device is a tablet.

In some embodiments of the system, the device screen includes a touch-screen configured to capture the user input.

In some embodiments of the system, the vehicle is an electrically powered vehicle.

In some embodiments of the system, the user interface is a touch-screenless interface.

In some embodiments of the system, the user interface comprises at least one of: an acceleration pedal, a brake pedal, a steering wheel, a headliner console, a center console, and a key fob.

In a fifth broad aspect of the present technology, there is provided a computer-implemented method for controlling a vehicle. The vehicle comprises a vehicle screen and a processor communicatively coupled to the vehicle screen. The method is executable by the processor. The method comprises triggering, by the processor, display of a first layout on the vehicle screen, the first layout including a first element indicative of a first vehicle function. The method comprises receiving, by the processor, an indication of a user device communicatively coupled to the processor, the user device including a device screen. The method comprises in response to the indication, triggering, by the processor, display of a second layout on the device screen in addition to the first layout on the vehicle screen, the second layout including a second element indicative of a second vehicle function. The method comprises receiving, by the processor, a user input from the user device. The method comprises control, by the processor, the second vehicle function based on the user input.

In some embodiments of the method, the first layout further includes a third element indicative of the second vehicle function.

In some embodiments of the method, the method further comprises in response to the indication, triggering, by the processor, display of a third layout on the vehicle screen instead of the first layout, the third layout including the first element and excluding the third element.

In some embodiments of the method, the method further comprises receiving, by the processor, an other indication of a plurality of vehicle functions controllable by the user of the vehicle, the plurality of vehicle functions include the first vehicle function and the second vehicle function. The method further comprises generating, by the processor, the first layout using the plurality of vehicle functions. The method further comprises in response to the indication, generating, by the processor, the second layout using a set of vehicle functions from the plurality of vehicle functions and including the second vehicle function.

For the purposes of the present application, terms related to spatial orientation such as forward, rearward, front, rear, upper, lower, left, and right, are as they would normally be understood by a driver of the vehicle sitting therein in a normal driving position with the vehicle being steered in a straight ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A is a left side elevation view of a vehicle according to a non-limiting embodiment of the present technology.

FIG. 1B is a top plan view of the vehicle of FIG. 1A.

FIG. 2A is a partial, cross-sectional view of the vehicle of FIG. 1A, taken along line 2-2 of FIG. 1B.

FIG. 2B is a perspective, schematic view of a chassis of the vehicle of FIG. 1A.

FIG. 3 is a schematic representation of a vehicle system of the vehicle of FIG. 1A.

FIG. 4 is a schematic representation of a user device according to at least some non-limiting embodiments of the present technology.

FIG. 5 is a partial, perspective view of a passenger compartment of the vehicle of FIG. 1A, with the user device of FIG. 4, and with front seats being omitted.

FIG. 6A is a partial perspective view of the vehicle in FIG. 5 without the user device.

FIG. 6B is an other partial, perspective view of the vehicle of FIG. 5.

FIG. 7A is a partial, perspective view of a passenger compartment of an additional vehicle, with front seats being omitted, and according to an additional non-limiting embodiment of the present technology.

FIG. 7B is a partial, perspective view of the additional vehicle of FIG. 7A and the user device of FIG. 4 mounted to the additional vehicle.

FIG. 8A is a screenshot of a home screen layout displayed by the user device of FIG. 4.

FIG. 8B is a screenshot of a first device layout displayed by the user device of FIG. 4.

FIG. 8C is a screenshot of a second device layout displayed by the user device of FIG. 4.

FIG. 9A is a screenshot of a first layout of displayed by the vehicle system of FIG. 3.

FIG. 9B is a screenshot of a second layout of displayed by the vehicle system of FIG. 3.

FIG. 9C is a screenshot of a third layout of displayed by the vehicle system of FIG. 3.

FIG. 10 is a scheme-block representation of a method, executable by a processor of the vehicle system of FIG. 3, in accordance with some non-limiting embodiments of the present technology.

It should be noted that, unless otherwise explicitly specified herein, the drawings are not necessarily to scale.

### DETAILED DESCRIPTION

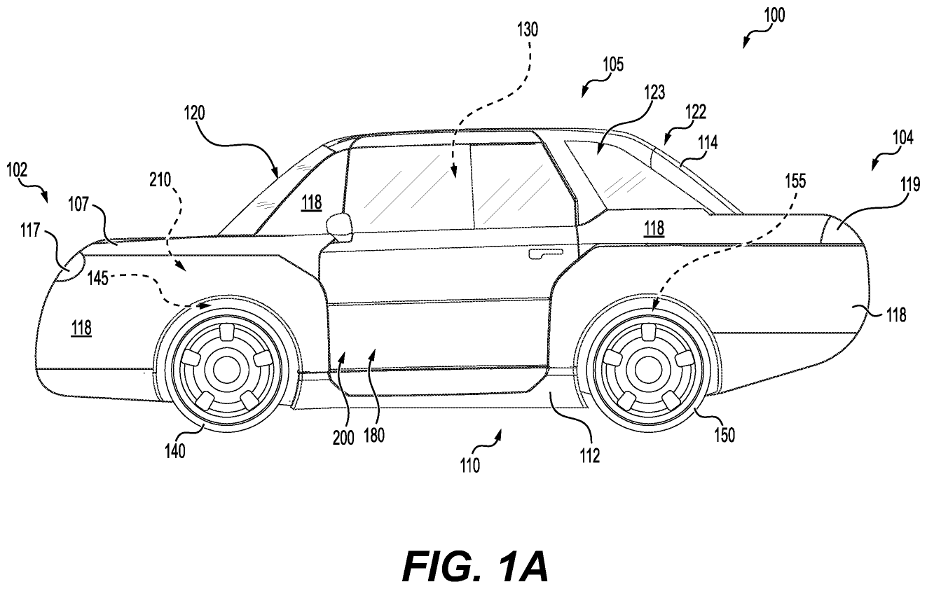

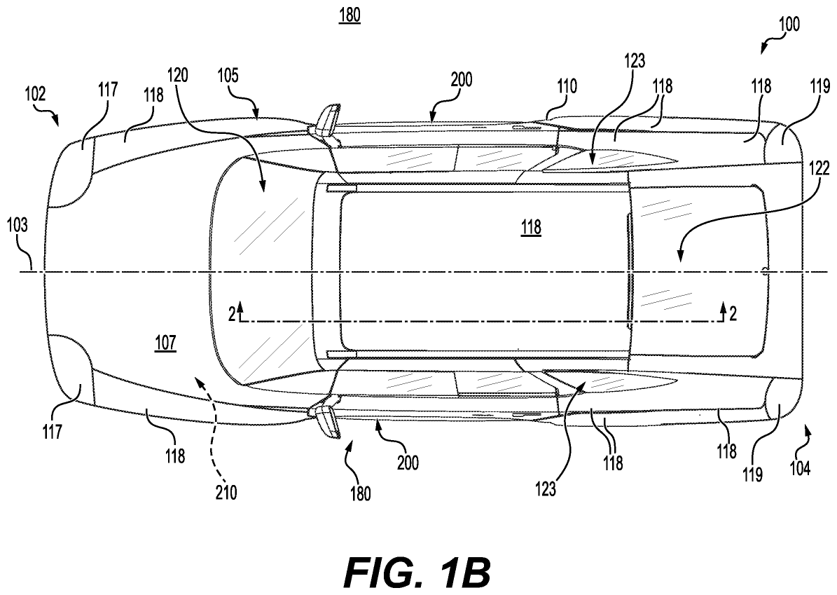

With reference to FIGS. 1A and 1B, there is depicted a two-door electric vehicle 100. It is contemplated that vehicles according to the present technology could vary by a plurality of vehicle characteristics. These vehicle characteristics could include, but are not limited to, a car type (sedan, coupe, etc.), tire type, a wheelbase, rear storage access (hatch back or trunk). It is contemplated that the vehicle 100 can be embodied as an electrical automobile. The general features of the vehicle 100 will now be described.

The vehicle 100 has a front end 102, a rear end 104, and a longitudinal center plane 103 defined consistently with the forward travel direction of the vehicle 100. The vehicle 100 has a vehicle body 105 defining the form and extent of the vehicle 100. In the present embodiment, the vehicle 100 is illustrated with a sedan-style vehicle body 105. It is contemplated that in different embodiments implementing the present technology, the vehicle body 105 could be of a variety of types, including but not limited to: hatchback, sports utility vehicle (SUV), multi-purpose vehicle (MPV), city car style, coupe, compact, and subcompact.

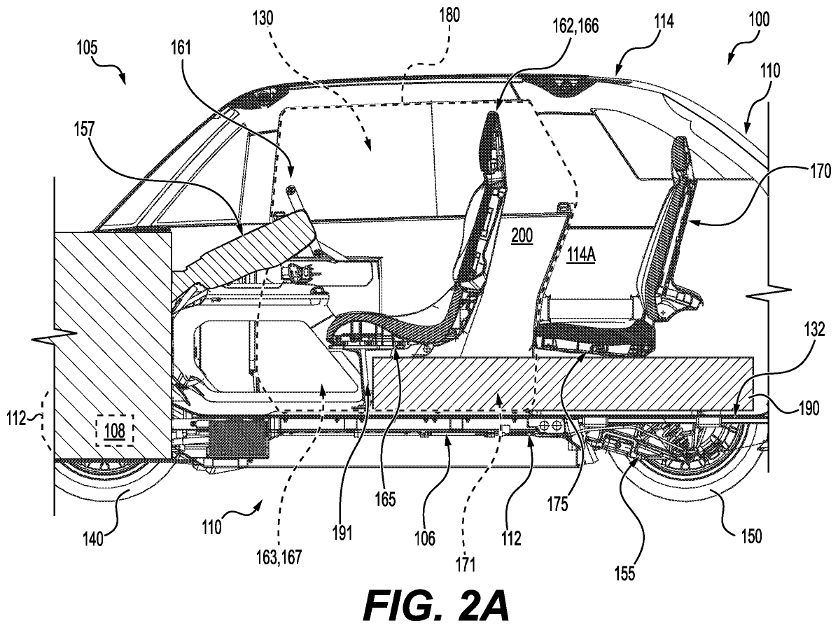

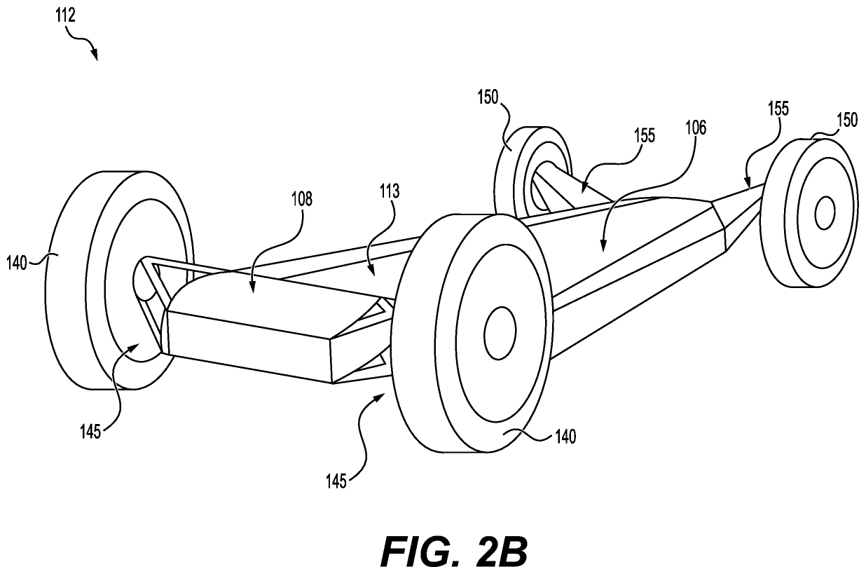

The vehicle 100 has a frame 110, also referred to as a frame assembly 110. The frame 110 supports and forms, in part, the vehicle body 105. In this embodiment, the frame 110 is formed from two parts: a lower base structure provided by an upper body frame 114 connected to and extending from the chassis 112 (see FIG. 2A) and a rolling platform type chassis 112 (see FIG. 2B).

The chassis 112 forms the rigid base structure of the frame 110. The rolling platform type chassis 112 has a generally horizontal structure to which the vehicle wheels are connected. Specifically, the vehicle 100 has two front wheels 140 connected to a front of the chassis 112 by front suspension assemblies 145. The vehicle 100 also includes two rear wheels 150 connected to a rear of the chassis 112 by rear suspension assemblies 155.

In the present embodiment, the rolling platform chassis 112 is specifically an electric-vehicle skateboard-type chassis 112. As best seen in FIGS. 2A and 2B, the chassis 112 includes a battery system 106 for providing power to the vehicle 100. The battery system 106 is packaged into a central portion of the chassis 112. The battery system 106 thus extends across a generally horizontal plane on a bottom side portion of the vehicle 100. Without limitation, it is contemplated that the battery system 106 could include, but is not limited to: batteries and/or battery cells, a charger, an inverter, etc.

The skateboard chassis 112 also includes an electric motor 108 connected thereto. The motor 108 is disposed in a forward portion of the chassis 112 for driving the front wheels 140. The chassis 112 includes a drivetrain (not shown) connecting the motor 108 to the wheels 140. It is contemplated that the motor 108 could be disposed in a rearward portion of the chassis 112 for driving the rear wheels 150. It is further contemplated that the chassis 112 could include two motors, one for driving each pair of wheels 140, 150. It is further contemplated that a drivetrain connecting the forwardly disposed motor 108 to the rear wheels 150 could be included in some embodiments. It is further contemplated that four motors could be provided, one for each wheel, including but not limited to direct-drive in-wheel type motors, also referred to as “hub motors”.

The motor 108 and the battery system 106 are packaged into the skateboard chassis 112, such that the structure of the chassis 112, the motor 108, and the battery system 106 form a unit. The battery system 106 is operatively connected to the motor 108 for providing power thereto, electrical connections (not shown) being encased in the body of the chassis 112.

It is contemplated that the upper body frame 114 can be formed from both a plurality of hollow frame tubes and a unibody portion. It is also contemplated that the upper body frame 114 could be formed entirely from a unibody or entirely from frame tubes. It should be noted that multiple unibody type structures could be included in the upper body frame 114, without departing from the scope of the present technology.

The upper body frame 114 is connected to and extends upward from a top surface 113 of the chassis 112. Specifically, a generally flat bottom portion 111 of the upper body frame 114 is disposed on the generally flat chassis top surface 113. The bottom portion 111 can be defined by the unibody portion, although a separate floor structure could be included in some embodiments. In the present embodiment, the upper body frame 114 is welded to the chassis 112, but different methods of connecting the chassis 112 and the upper body frame 114 are contemplated, such as bolts and adhesives.

In the illustrated embodiment, the vehicle 100 further includes a forward subframe (not shown in FIG. 2A) and a rearward subframe (not shown in FIG. 2A) defining forward and rearward portions of the vehicle body 105.

Returning to FIGS. 1A and 1B, the vehicle 100 further includes body panels 118 for defining, in part, the vehicle body 105. The body panels 118 are connected to the frame 110, specifically to the upper body frame 114, as well as to the forward and rearward subframes. The panels 118 help protect the internal components of the vehicle 100, provide aerodynamic features, and provide some of the aesthetic features of the vehicle 100.

Forwardly disposed panels 118 define two apertures inside which two front illumination assemblies 117 of the vehicle 100 are disposed. The front illumination assemblies 117 include front headlamps, front turn indicator lamps, and front high beams (not separately identified). Depending on the embodiment, additional or alternative front lights could be included in the front illumination assemblies 117. It is also contemplated that the panels 118 could define additional apertures for receiving additional separate front illumination or reflective components.

Rearwardly disposed panels 118 define two apertures inside which two rear illumination assemblies 119 of the vehicle 100 are disposed. The rear illumination assemblies 119 include brake lights, rear turn indicator lamps, and reverse indicator lamps (not separately identified). Depending on the embodiment, additional or alternative rear lights could be included in the rear illumination assemblies 119. It is also contemplated that the panels 118 could define additional apertures for receiving additional separate rear illumination or reflective components.

The vehicle body 105 also includes a front hood 107 pivotally connected to the frame 110 for selectively providing access to at least some forward vehicle components. The vehicle body 105 also includes a rear trunk door 109 for selectively closing a rear trunk storage space (not shown). Depending on the particular embodiment, including for example vehicle body type, the hood 107 and/or the trunk door 109 could have different forms. It is also contemplated that the hood 107 and/or the trunk door 109 could be replaced by immovable body panels 118 in some embodiments. It is further contemplated that other storage spaces closed by respective movable panels, instead of or in addition to the front hood 107 and/or rear trunk door 109, could be provided in some embodiments.

The vehicle body 105 includes a front windshield 120 extending laterally across a forward portion of the upper body frame 114. The vehicle body 105 also includes a rear window 122 extending laterally across a rearward portion of the upper body frame 114. The vehicle body 105 further includes two rear side windows 123, one window 123 being disposed on each side of the vehicle 100. Depending on the particular car type of a given embodiment of the vehicle 100, the rear side windows 123 could be omitted in some cases. It is also contemplated that additional side windows could be included in different embodiments.

The vehicle body 105 also defines therein two openings 180 through which a driver or passenger can enter or exit the vehicle 100. A right side opening 180 is defined in a right side of the vehicle body 105 and a left side opening 180 is defined in a left side of the vehicle body 105. The right side opening 180 is selectively closed by a right side door 200 movably connected to a right side the vehicle body 105. The left side opening 180 is selectively closed by a left side door 200 movably connected to a left side the vehicle body 105.

With reference to FIG. 2A, the vehicle 100 includes a passenger compartment 130, inside which passengers (including a driver) of the vehicle 100 are situated during operation of the vehicle 100. The passenger compartment 130 is defined by the vehicle body 105. Specifically, the passenger compartment 130 is defined by an interior surface of the upper body frame 114 and the body panels 118 connected thereto. While not illustrated explicitly, the interior surface of the vehicle body 105 defining the passenger compartment 130 is generally covered with surface finishing materials, including but not limited to: carpeting, plastic and/or wood paneling, liner fabric, and insulating materials.

A floor 132 of the passenger compartment 130 is formed by a top surface of the bottom portion 111 of the upper body frame 114. Although not specifically illustrated, it is contemplated that the floor 132 defined by the bottom portion 111 is generally covered by noise and/or heat insulating material and automotive carpeting. As is mentioned above, the bottom portion 111 is formed over the top surface 113 of the skateboard chassis 112 and is generally flat. The floor 132 of the passenger compartment 130 is similarly generally flat along a longitudinal length of the passenger compartment 130, being formed upon the bottom portion 111 of the upper frame body 114.

The vehicle 100 includes two front seats disposed in the passenger compartment 130. Specifically, the vehicle 100 includes a driver seat 162 and a front passenger seat 166. In the present embodiment, the driver seat 162 is disposed on the left side of the center plane 103 and the passenger seat 166 is disposed on the right side of the center plane 103. It is contemplated, however, that the driver seat 162 could be disposed on the right side of the vehicle 100 and that the passenger seat 166 could be disposed on the left side of the vehicle 100.

The vehicle 100 includes two front legroom spaces defined in the passenger compartment 130. Passengers of the vehicle 100 generally enter the passenger compartment 130 through the legroom spaces and position their legs therein when occupying the front seats 162, 166. Specifically, a driver side front legroom space 163 is defined forward of the driver seat 162 in the passenger compartment 130. A passenger side front legroom space 167 is defined forward of the passenger seat 166 in the passenger compartment 130. A rear side of each legroom space 163, 167 is generally defined by the corresponding seat 162, 166. A front side of each legroom space 163, 167 is generally defined by a front, interior side of the vehicle body 105. A driver side footwell 164 defines at least a portion of a forward extent of the driver side front legroom space 163. A passenger side footwell 168 defines at least a portion of a forward extent of the passenger side front legroom space 167. It is contemplated that additional or alternative structures or components could define the legroom spaces 163, 167. For example, structures defining the front side of each legroom space 163, 167 could include, but is not limited to: a dashboard, a glove box, and a center console.

The vehicle 100 further includes rear seating, also referred to as a second row of seating. In the illustrated embodiment, the vehicle 100 includes a rear bench seat 170 disposed in the passenger compartment 130. The rear bench seat 170 is disposed rearward of the front seats 162, 166. The rear bench seat 170 configured to seat a plurality of passengers. In the illustrated embodiment, the rear bench seat 170 is arranged to seat three passengers. In at least some embodiments, the rear bench seat 170 could be configured to receive and seat two passengers. In at least some embodiments it is contemplated that the rear bench seat 170 could be replaced with two or three individual rear seats.

The rear bench seat 170 extends laterally over at least a majority of a width 133 of the passenger compartment 130. The rear bench seat 170 is supported by the upper body frame 114, specifically lateral, generally vertically extending side portions 114A (walls 114A) of the upper body frame 114. Lateral ends 174 of the rear bench seat 170 are connected to opposite lateral sides 114A of the upper body frame 114. As such, the rear bench seat 170 extends laterally over an entirety of the width 133 of the passenger compartment 130 in the illustrated embodiment. It is contemplated that the rear bench seat 170, or other implementations of rear seating, could be differently installed in the passenger compartment 130, for example using vertically extending seating legs connected to the floor 132 of the passenger compartment 130.

The vehicle 100 also includes a rear legroom space 171 defined longitudinally between the rear bench seat 170 and the front seats 162, 166. The rear legroom space 171 extends laterally through the passenger compartment 130. In at least some embodiments, it is contemplated that the rear legroom space 171 could be laterally interrupted by additional components disposed longitudinally between the front seats 162, 166 and the rear bench seat 170. For example, a center console could be disposed between the front seats 162, 166 and extend rearward at least partially into the rear legroom space 171.

The vehicle 100 further includes a storage volume 190 defined in the passenger compartment 130. The storage volume 190 is formed by the arrangement of components disposed in the passenger compartment 130, including at least the front seats 162, 166 and the rear bench seat 170, as well as the form of the upper body frame 114.

The storage volume 190 is defined in part by the floor 132 of the passenger compartment 130, the floor 132 being generally flat as mentioned above. The lateral limits of the storage volume 190 are formed by the lateral sides 114A of the upper body frame 114. A portion of the storage volume 190 is defined by an underside 175 of the rear bench seat 170. Upper limits on other portions of the storage volume 190 are further defined by an underside 165 of the driver seat 162 and an underside (not shown) of the front passenger seat 166. There is additionally a wall 191 disposed below the driver seat 162 for limiting a forward extent of the storage volume 190. The wall 191 extends from the floor 132 to the underside 165 of the driver seat 162. The wall 191 separates the driver side legroom 163 from the storage space 190.

The vehicle 100 comprises a steering wheel 161 is disposed in front of the driver seat 162. The steering wheel 161 is used to turn the front wheels 140 to steer the vehicle 100 via a steering assembly 157. However, it should be noted that the vehicle 100 includes additional components disposed in the passenger compartment 130 for operation by and accommodation of passengers of the vehicle 100. To that end, the vehicle 100 includes a control system 210.

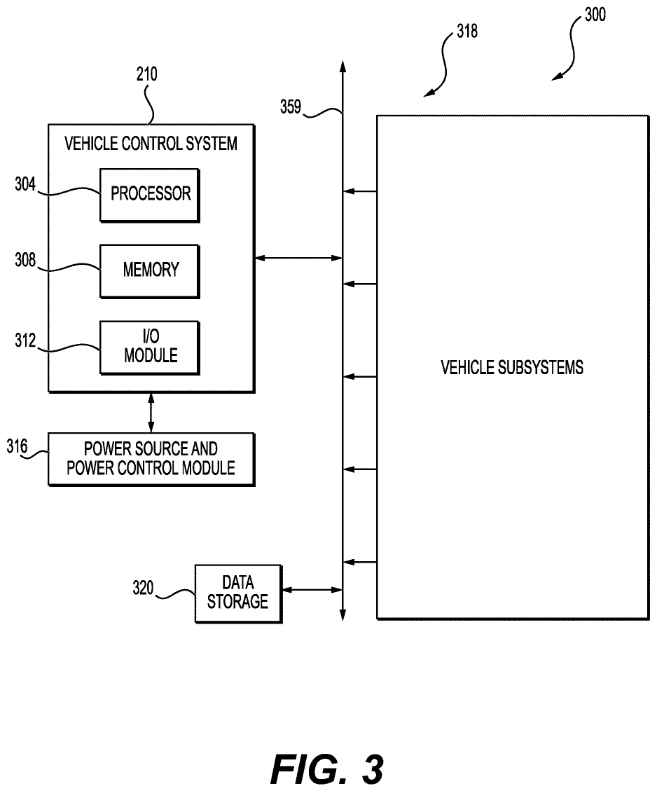

With reference to FIG. 3, there is depicted a vehicle control environment 300 including the vehicle control system 210. The vehicle control system 210 includes a processor 304, memory 308, and an input/output (I/O) module 312. Thus, the vehicle control system 210 is generally a computer system, which can include hardware elements that may be electrically coupled. The hardware elements generally include one or more central processing units (CPUs) 304; one or more components of the I/O module 312 including input devices (e.g., touchscreen.) and/or one or more output devices (e.g., a display device). Specifics could vary in different embodiments.

The processor 304 may include a general-purpose programmable processor or controller for executing application programming or instructions. The processor 304 may, optionally, include multiple processor cores, and/or implement multiple virtual processors. Additionally or alternatively, the processor 304 may include multiple physical processors. As a particular example, the processor 304 may include a specially configured application specific integrated circuit (ASIC) or other integrated circuit, a digital signal processor, a controller, a hardwired electronic or logic circuit, a programmable logic device or gate array, a special purpose computer, or the like. The processor 304 generally functions to run programming code or instructions implementing various functions of the vehicle control system 210.

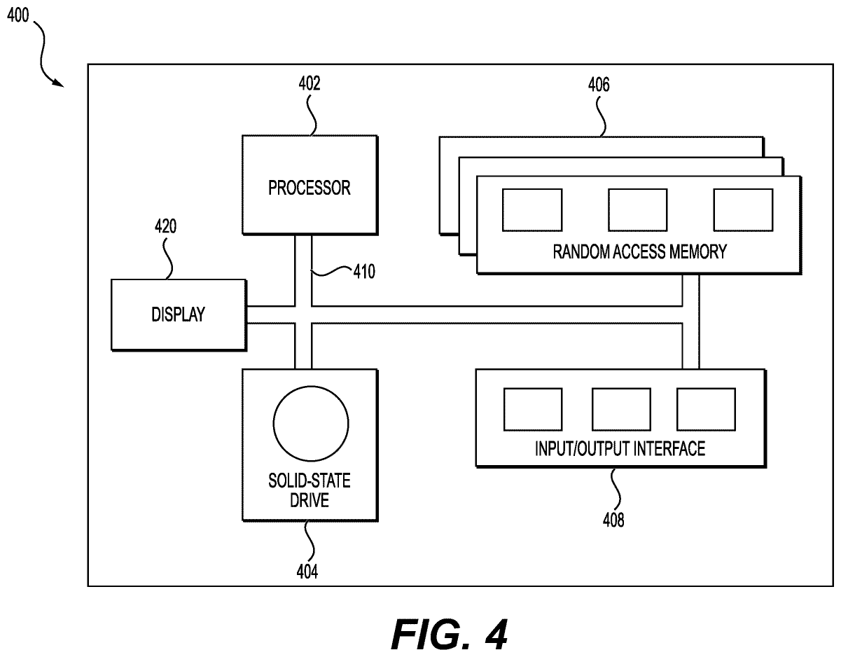

The I/O module 312 and associated ports may be included to support communications over wired or wireless networks or links, for example with other communication devices, server devices, and/or peripheral devices. The input/output module 312 may be configured to establish a communication link (wired and/or wireless) with a user device 400 (see FIG. 4). Examples of an input/output module 312 include an Ethernet port, a Universal Serial Bus (USB) port, Institute of Electrical and Electronics Engineers (IEEE) 1594, or other interface. It is contemplated that the I/O module 312 may be configured to establish at least one of a wired communication link, a Bluetooth communication link, and a Wi-Fi communication link, with the user device 400. As it will be described below, the vehicle control system 210 may make use of the I/O module 312 for communicatively coupling with the user device 400 associated with the user/operator of the vehicle 100.

The vehicle control system 210 includes one or more storage devices 308. By way of example, storage devices 308 may be disk drives, optical storage devices, solid-state storage devices such as a random access memory (“RAM”) and/or a read-only memory (“ROM”), which can be programmable, flash-updateable and/or the like. The vehicle control system 210 may additionally include a computer-readable storage media reader; a communications system (e.g., a modem, a network card (wireless or wired), an infra-red communication device, etc.); and working memory 308, which may include RAM and ROM devices as described above. The vehicle control system 210 may also include a processing acceleration unit, which can include a digital signal processor (DSP), a special-purpose processor, and/or the like.

The computer-readable storage media reader can further be connected to a computer-readable storage medium, together (and, optionally, in combination with storage device(s)) comprehensively representing remote, local, fixed, and/or removable storage devices plus storage media for temporarily and/or more permanently containing computer-readable information. The communications system may permit data to be exchanged with an external or internal network and/or any other computer or device described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices, and/or other machine readable mediums for storing information.

The vehicle control system 210 also generally includes software elements including an operating system and/or other code. It should be appreciated that alternates to the vehicle control system 210 may have numerous variations from that described herein. For example, customized hardware might also be used and/or particular elements might be implemented in hardware, software (including portable software, such as applets), or both. Further, connection to other computing devices such as network input/output devices may be employed.

The power source and/or power control module 316 can include any type of power source, including, but not limited to, the vehicle batteries. One or more components or modules may also be included to control the power source or change the characteristics of the provided power signal. Such modules can include one or more of, but is not limited to, power regulators, power filters, alternating current (AC) to direct current (DC) converters, DC to AC converters, receptacles, wiring, other converters, etc. The power source and/or power control module 316 functions to provide the vehicle control system 210 and any other system with power.

A data storage module 320 can include any module for storing, retrieving, and/or managing data in one or more data stores and/or databases. The database or data stores may reside on a storage medium local to (and/or resident in) the vehicle control system 210 or in the vehicle 100. Alternatively, some of the data storage capability may be remote from the vehicle control system 210 or automobile, and in communication (e.g., via a network) to the vehicle control system 210. The database or data stores may reside in a storage-area network (“SAN”) familiar to those skilled in the art. Similarly, any necessary files for performing the functions attributed to the vehicle control system 210 may be stored locally on the respective vehicle control system 210 and/or remotely, as appropriate. The databases or data stores may be a relational database, and the data storage module 210 may be adapted to store, update, and retrieve data in response to specifically-formatted commands. The data storage module 320 may also perform data management functions for any flat file, object oriented, or other type of database or data store.

One example data store that may be part of the vehicle control environment 300 is a profile data store for storing data about user profiles and data associated with the users. An additional example of data store may include vehicle function data store for storing data to be used for controlling one or more vehicle functions of the vehicle 100. An other example of data store may include a system data store used by the vehicle control system 210 and/or one or more of the plurality of vehicle subsystems 318 to facilitate the functionality described herein.

The vehicle control environment 300 includes a plurality of vehicle subsystems 318. The plurality of vehicle subsystems 318 may include one or more of, but is not limited to, a power source and/or power control module, a data storage module, user interface(s)/input interface(s), navigation subsystems, sensor(s) and/or sensor subsystems, communication subsystems, media subsystems, and/or device interaction subsystems. The subsystems, modules, components, etc. may include hardware, software, firmware, computer readable media, displays, input devices, output devices, etc. or combinations thereof. The system, subsystems, modules, components, etc. may communicate over a network or bus 356. This communication bus 356 may be bidirectional and perform data communications using any known or future-developed standard or protocol.

The vehicle control system 210 is communicatively coupled with the plurality of vehicle subsystems 318 to control operation of the vehicle and/or of one or more functions thereof. As will be described in greater details herein further below, the vehicle control system 210 may communicate with the user interfaces for providing information or data and/or for receiving input or data from a user, and/or for controlling operation of the vehicle 100 and/or one or more functions of the vehicle 100 based on the input or data from the user.

The plurality of vehicle subsystems 318 may include a variety of the mechanical, electrical, electromechanical, computer, and/or other systems associated with the function of the vehicle 100. For example, the plurality of vehicle subsystems 318 may include one or more of, but is not limited to, the steering system (e.g., comprising the steering assembly 157 and the steering wheel 161), the braking system, the engine (e.g., the motor 108) and engine control systems, electrical system, suspension, drive train, cruise control system, radio, heating, ventilation, air conditioning (HVAC) system, windows and/or doors, and the like.

As mentioned above, the vehicle control system 210 may be configured to communicatively couple with the user device 400 associated with the operator of the vehicle 100. With reference to FIG. 4, there is depicted a high-level functional block diagram of a computing environment included in the user device 400, in accordance with various non-limiting embodiments of the present disclosure.

In some embodiments, the user device 400 may be implemented by any of a conventional personal computer, a computer dedicated to operating representing information to an operator, a remote server and/or an electronic device (such as, but not limited to, a mobile device, a tablet device, a server, a controller unit, a control device, a monitoring device, etc.) and/or any combination thereof appropriate to the relevant task at hand. In some alternative embodiments, the computing environment 400 may be a generic computer system, laptop, tablets, smartphones, or the like. In some embodiments, the computing environment 400 includes various hardware components including one or more single or multi-core processors collectively represented by a processor 402, a solid-state drive 404, a random access memory 406, and an input/output interface 408.

In some other embodiments, the user device 400 may be an “off the shelf” generic computer system. In some embodiments, the computing environment 400 may also be distributed amongst multiple systems. In some embodiments, the computing environment 400 is virtualized in the “cloud” so that processing power and/or memory capacity may be scaled up or down depending on actual needs for executing implementations of the present technology. The user device 400 may also be specifically dedicated to the implementation of the present technology. In some embodiments, the user device 400 may be configured to operate in offline mode and all the operation may be performed locally on the user device 400 without the need to any communication with an external server/cloud. In offline mode, the user device 400 may also be configured to share its data with the server/cloud whenever a connection to the network is ready. In some embodiments, the user device 400 may be configured to operate to perform at least some of its operations in online mode that is, the user device 400 may be connected to a network to increase processing power and/or memory capacity. As a person in the art of the present technology may appreciate, multiple variations as to how the user device 400 is implemented may be envisioned without departing from the scope of the present technology.

Communication between the various components of the computing environment 400 may be enabled by one or more internal and/or external buses 410 (e.g. a PCI bus, universal serial bus, IEEE 1394 “Firewire” bus, SCSI bus, Serial-ATA bus, ARINC bus, CAN bus etc.), to which the various hardware components are electronically coupled.

The I/O interface 408 may allow enabling networking capabilities such as wire or wireless access. As an example, the I/O interface 408 may include a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network, allowing communication among small groups of computers on the same local area network (LAN) and large-scale network communications through routable protocols, such as Internet Protocol (IP).

According to implementations of the present technology, the solid-state drive 404 stores program instructions suitable for being loaded into the random access memory 406 and executed by the processor 402 for providing information to the operator. For example, the program instructions may be part of a library, an application, API, framework, Software as a service (Saas) or the like. The solid-state drive 404 may also store various databases including metadata, user information such as login, activity history or the like.

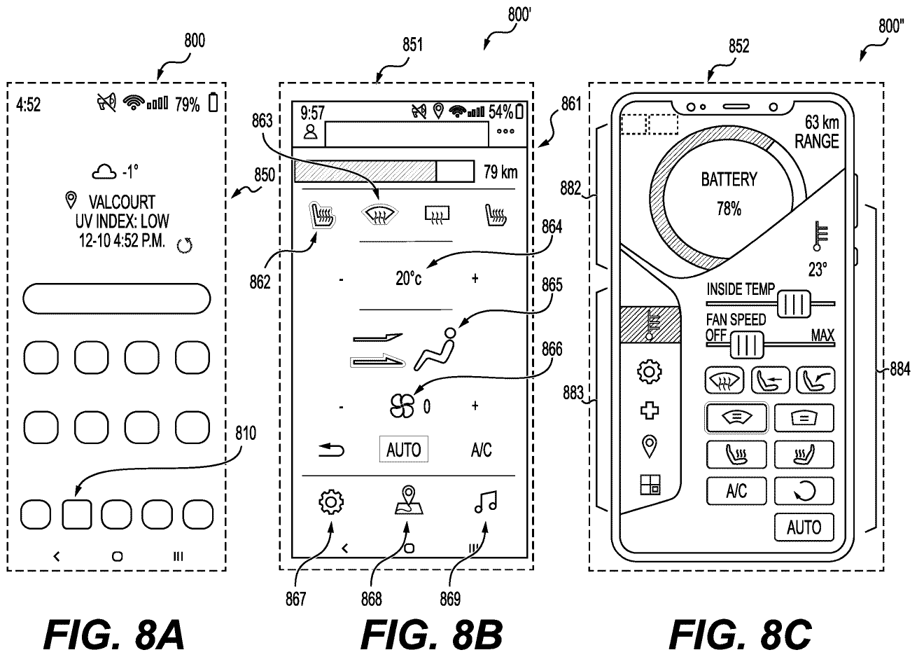

In certain non-limiting embodiments, the display 420 may be coupled with the processor 402, the solid-state drive 404, random access memory 406, I/O interface 408 via one or more internal and/or external buses 410. The processor 402 may be configured to execute the instructions stored in the solid-state drive and/or the random-access memory 406 and may control the content to be displayed on the display 420 (such as layouts shown in FIGS. 8A-8C, for example).

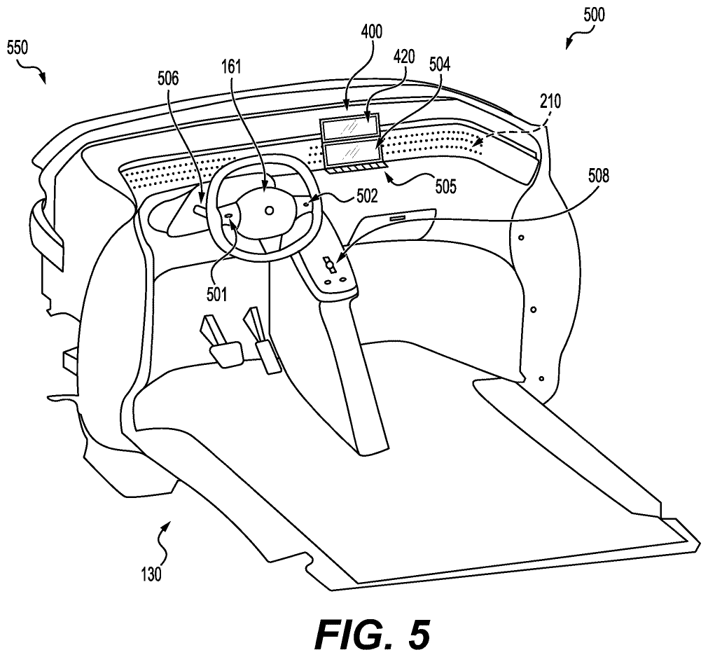

With reference to FIG. 5, there is depicted a perspective view 500 of the passenger compartment 130. A user interface 550 includes a plurality of components for operating the vehicle 100 and/or receiving input or data from the user and/or for controlling one or more vehicle functions of the vehicle 100. Examples of vehicle functions will now be presented with reference to various components of the user interface 550 that can enable control of those vehicle functions.

The user interface 550 includes steering mounted controls 501 and 502. The steering mounted controls 501 and 502 may be used to control vehicle functions such as cruise control speed, for example, and may also include a configurable button for controlling a user device and/or a vehicle screen 504.

The user interface 550 also includes a plurality of buttons 505. In one example, the plurality of buttons 505 may include a start/stop button. At least one of the plurality of buttons 505 may provide information to the user. At least one of the plurality of buttons 505 may be used to control vehicle functions such as liftgate locking/unlocking, door locking/unlocking, for example. The user interface 550 includes steering stalks 506. The steering stalks 506 may be used to control vehicle functions such as cruise control, front wiper, rear wiper, parking lights, high beam lights, fog lights, turn signals, and the like. The user interface 550 includes a center console 508. The center console 508 may be used to control vehicle functions such as hand brake, DC out, AC out, for example. The user interface 550 includes the steering wheel 161. The steering wheel 131 may be used to control a vehicle function such as a horn, for example.

In addition to the user interface 550, the device screen or display 420 of the user device 400 may be used for controlling at least some vehicle functions of the vehicle 100. It can be said that in some embodiments of the present technology, the user interface 550 (native to the vehicle 100) and the user device 400 (non-native to the vehicle 100) form an augmented user interface for the user. The device screen 420 may be used to control vehicle functions such as driver seat heating, passenger seat heating, HVAC controls, liftgate locking/unlocking, door locking/unlocking, rear window defrosting, steering heating, key-less start-up, and the like. The device screen 420 may be used to provide vehicle information such as navigation, media player, battery SOC, charge time, and the like. At least some examples of layouts displayable by the device screen 420 will be discussed in greater details herein further below. The user device 400 may be selectively mounted to the vehicle via a mounting bracket disposed in proximity to the vehicle screen 504.

The user interface 550 includes the vehicle screen 504. The vehicle screen 504 is disposed in the passenger compartment 130 to provide information to the driver regarding the operating conditions of the vehicle 100. In some embodiments, the vehicle screen 504 may display a speedometer, a battery state of charge, a vehicle range, and a vehicle drive mode (park, drive, reverse), as well as symbols indicating the activation of turn signals, head lights, a parking brake, a regenerative braking level and various fault conditions (for example, high battery temperature, low battery, limited power, and electrical fault). Additional components are contemplated to be included in the passenger compartment 130, including but not limited to: a rear view mirror, seat belts, navigational systems, heating systems, sound systems, storage compartments, and safety features.

In other embodiments of the present technology, the vehicle screen 504 may provide vehicle information and/or may be used to control vehicle functions such as headlight angle, driver seat heating, passenger seat heating, HVAC controls, rear window defrosting, steering heating, vehicle speed, digital rear view, driving modes, Electronic Stability Control (ESC) switch, lane keep/assist, battery State Of Charge (SOC), battery State Of Health (SOH), distance to empty, charging status, cruise control, automatic emergency braking, front collision avoidance, transmission selection, vehicle OFO, Electric Vehicle (EV) system ready status, turn signals, main beam, traction/stability control, malfunction indicator, Anti-locking Braking System (ABS) warning, low brake fluid, break pad wear, airbag warning, battery low status, hazard lights, dipped beam, blind spot detection, seat belt warning, sidelight, park brake, tyre pressure, coolant temperature, and the like.

It is contemplated that the user interface 550 may include a headliner console (not depicted). For example, the headliner console may be used to control vehicle functions such as dome lights, hazard lights, and the like. It is contemplated that the user interface 550 may include a communication interface. The communication interface may be used to control vehicle functions such as Bluetooth connectivity and/or Wi-Fi connectivity and/or wired connectivity. It is contemplated that the user interface 550 may include an FOB key. The FOB key may be used to control vehicle functions such as liftgate locking/unlocking, door locking/unlocking, key-less start-up, and the like.

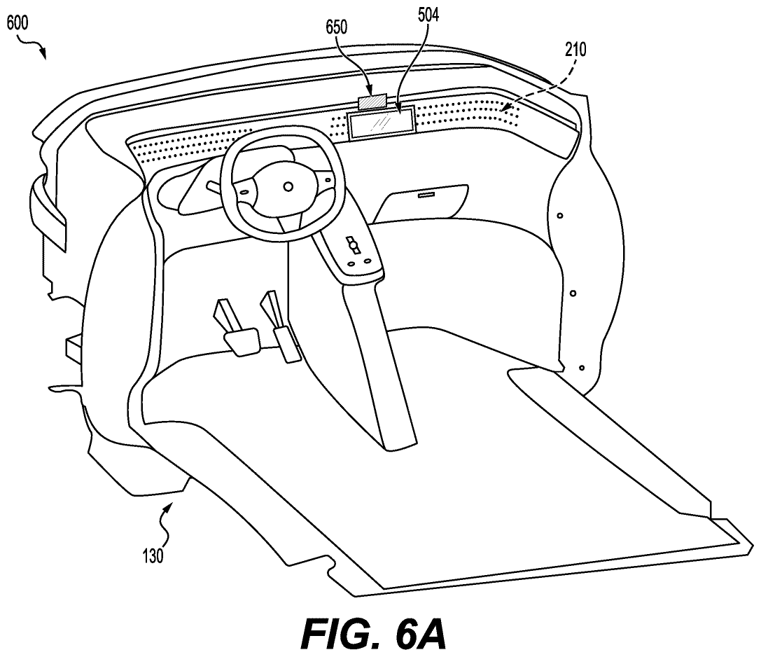

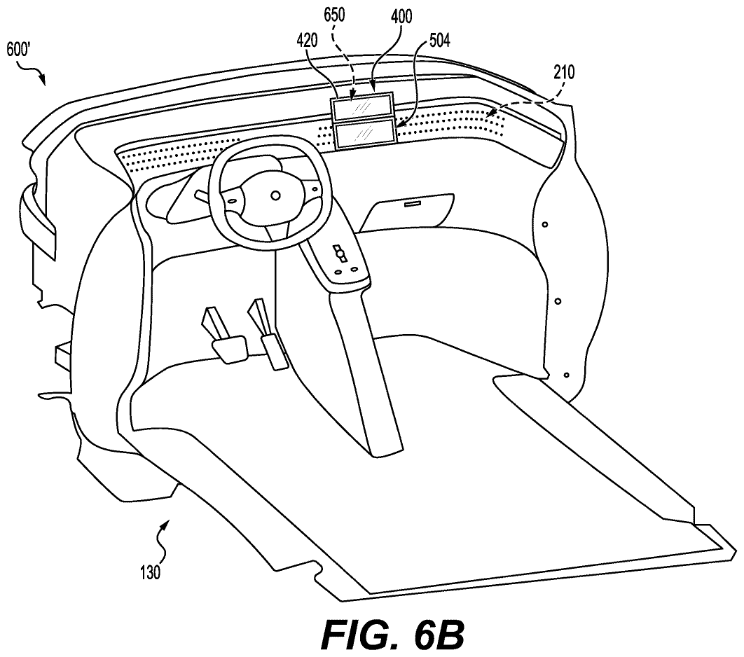

With reference to FIG. 6A, there is depicted an other perspective view of the vehicle 100 with front seats omitted and without the user device 400. There is shown inter alia the passenger compartment 130, the vehicle control system 210, and the vehicle screen 504. Other components of the vehicle 100 are not numbered for sake of simplicity only.

The vehicle 100 also includes a mounting bracket 650 disposed in proximity to the vehicle screen 504. The mounting bracket 650 is configured to selectively hold the user device 400. For example, with reference to FIG. 6B, the user can mount the user device 400 onto the mounting bracket 650. It should be noted that, in this embodiment, when the user device 400 is mounted onto the mounting bracket 650, the device screen 420 is adjacent to the vehicle screen 504. Developers have realized that adjacent juxtaposition of the device screen 420 with the vehicle screen 504 may be appealing to the user.

In some embodiments, a wired connection module may be integrated into the mounting bracket 650 for establishing wired communication between the user device 400 and the vehicle control system 210. In other embodiments, a wireless connection module of the vehicle control system 210 may be used for establishing wireless communication between the user device 400 and the vehicle control system 210.

In some embodiments of the present technology, in response to the vehicle control system 210 of the vehicle 100 being communicatively coupled with the user device 400, the vehicle control system 210 may trigger display of information on the device screen 420 and on the vehicle screen 504. In some embodiments of the present technology, in response to the vehicle control system 210 of the vehicle 100 being communicatively coupled with the user device 400, the vehicle control system 210 may receive user input from the device screen 420 and/or from the vehicle screen 504. Developers have realized that so employing the device screen 420 in combination with the vehicle screen 504 provides an augmented screen area for displaying information to the user and/or for receiving user inputs from the user. Indeed, the augmented screen area allows for a larger visual display and a larger area for capturing user inputs.

It is contemplated that the additional visual real-estate provided by the device screen 420 may allow more information to be displayed at once to the user during operation of the vehicle 100. It is contemplated that the additional visual real-estate provided by the device screen 420 may allow for larger font and/or icon size to be displayed for better visibility and clarity of information being displayed. Developers have also realized that the cost of the vehicle control system 210 and of the vehicle 100 itself may thus be reduced by making use of the user device 400 of the user, that (s)he may already possess, to display vehicle information and/or receive user input during operation of the vehicle 100 for controlling one or more vehicle functions of the vehicle 100.

In some embodiments, at least some information may be displayed exclusively on the vehicle screen 504, irrespective of whether the user device 400 is communicatively coupled with the vehicle control system 210 of the vehicle 100. For example, vehicle speed may be displayed exclusively on the vehicle screen 504. In other embodiments, at least some information may be displayed exclusively on the device screen 420 when the user device 400 is communicatively coupled with the vehicle control system 210 of the vehicle 100. For example, media player information and/or navigation information may be displayed exclusively on the device screen 420. It is contemplated at least some information may be displayed on one, the other, or both of the vehicle screen 504 and the device screen 420, without departing from the scope of the present technology.

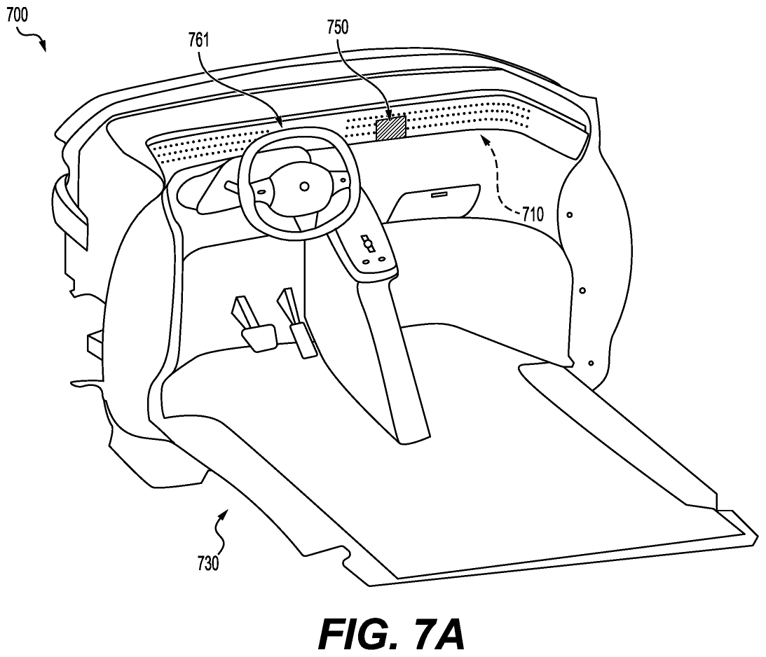

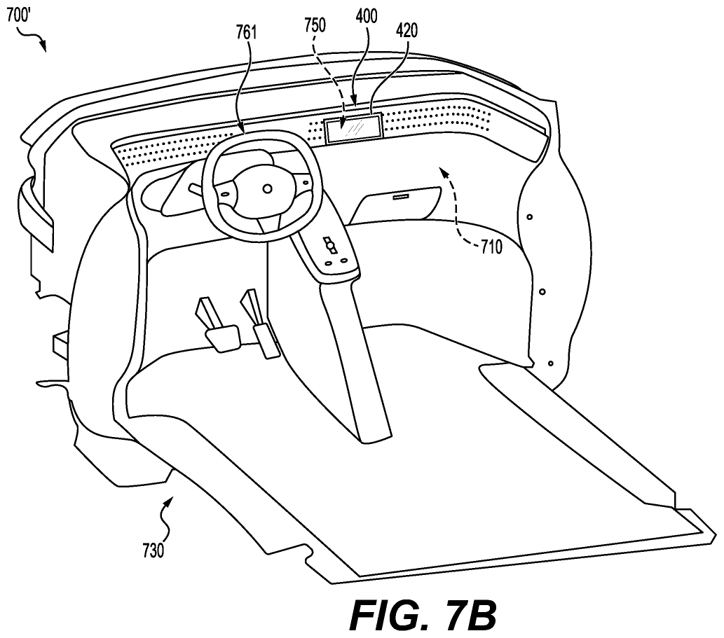

With reference to FIG. 7A, there is depicted a perspective view of a vehicle 700 with front seats omitted. The vehicle 700 includes inter alia a passenger compartment 730, a steering wheel 761, and a vehicle control system 710. It is contemplated that the vehicle 700 may be implemented in a similar manner to the vehicle 100, and therefore other components of the vehicle 700 will not be discussed in greater details for sake of brevity. However, it should be noted that the vehicle 700 does not include a vehicle screen, as opposed to the vehicle 100 with the vehicle screen 504, for example.

The vehicle 700 also includes a mounting bracket 750, similarly to the vehicle 100 with the mounting bracket 650. The mounting bracket 750 is configured to selectively hold the user device 400. For example, with reference to FIG. 7B, the user can mount the user device 400 onto the mounting bracket 750.

It should be noted that a wired connection module may be integrated into the mounting bracket 750, such that when the user device 400 is mounted onto the mounting bracket 750, the vehicle control system 210 communicatively couples with the user device 400 and making the device screen 420 available for displaying information to the user and/or receive user input during operation of the vehicle 700 for controlling one or more vehicle functions of the vehicle 700.

Developers of the present technology have realized that a vehicle screen (such as the vehicle screen 504) may be replaced by the device screen 420 altogether, thereby further reducing the cost of the vehicle control system 710 and of the vehicle 700 itself.

In some embodiments, at least some primary information and/or primary vehicle functions, such as vehicle speed, warning icons, start/stop functions, parking gear, driving gears, reverse gear, and the like, may be available via other components of a user interface of the vehicle 700. In these embodiments, at least some secondary information and/or secondary vehicle functions, such as HVAC controls, heating, media player and navigation information, may be uniquely available via the device screen 420 when the user device 400 is communicatively coupled to the vehicle control system 710. Therefore, in at least some embodiments of the present technology, at least one vehicle function may be uniquely controllable via the user device 400 and that is otherwise not controllable via the user interface native to the vehicle 700.

In FIG. 8A, there is depicted a screenshot 800 of a home screen layout 850 of the user device 400. There is depicted a plurality of elements (not numbered) corresponding to a plurality of applications executable by the user device 400. The plurality of elements includes an element 810 corresponding to an application associated with the vehicle control system 210 of the vehicle 100. The application shown via the element 810 is a computer program designed to run on the user device 400 and may be developed by the manufacturer of the vehicle 100.

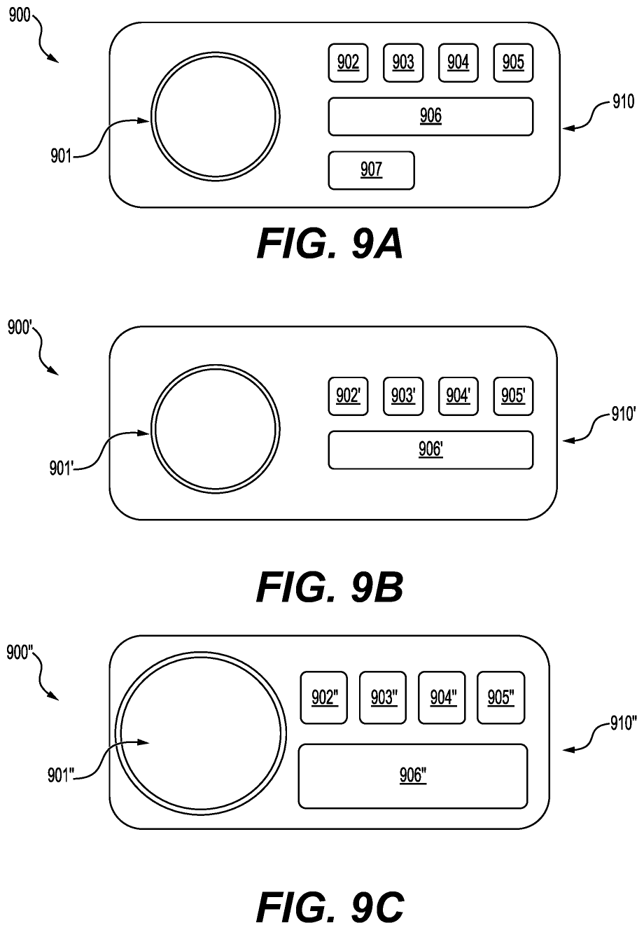

In FIG. 9A, there is depicted a screenshot 900 of a first layout 910 displayed to the user via the vehicle screen 504 prior to the vehicle control system 210 being communicatively coupled to the user device 400. The first layout 910 includes elements 901 to 907 corresponding to vehicle information and/or vehicle functions controllable via the vehicle screen 504. For example, the elements 901 to 907 may correspond to vehicle information and/or vehicle functions such as, but not limited to: vehicle speed, headlight angle, seat heating, steering wheel heating, HVAC controls, digital camera feed, driving mode, charge status, charge time, cruise control, turn signal, tyre pressure, and the like.

Returning to FIG. 8A, the user can launch the application by interacting with the element 810. The user device 400 is configured to communicatively couple with the vehicle control system 210 via a communication link (e.g., wired or wireless) and upon launching the application, the vehicle control system 210 may trigger the user device 400 to display on the device screen 420 a device layout 851 shown on FIG. 8B and/or an other device layout 852 shown on FIG. 8C with vehicle information and/or vehicle functions controllable via the user device 400.

In FIG. 8B, there is depicted a screenshot 800′ showing the device layout 851. The device layout 851 includes inter alia elements 861 to 869 corresponding to vehicle information and/or vehicle functions controllable via the user device 400. For example, the element 861 corresponds to a current driving range of the vehicle 100, the element 862 corresponds to a seat heating, the element 863 corresponds to the windshield defrost, the element 864 corresponds to temperature control, the element 865 corresponds to heating zone control, the element 866 corresponds to ventilation control, the element 867 corresponds to a settings menu, the element 868 corresponds to navigation menu, and the element 869 corresponds to media player menu.

The user can interact with the user device 400 for controlling one or more of the above-listed vehicle functions. For example, in response to the user interacting with one of the elements 861 to 869, the vehicle control system 210 may receive an indication of a user input for controlling a corresponding vehicle function. In response to the indication, the vehicle control system 210 is configured to control the corresponding vehicle function in accordance with the user input. It is contemplated that the user device 400 may display the device layout 851 and capture user input with various elements displayed thereto during operation of the vehicle 100.

In FIG. 8C, there is depicted a screenshot 800″ showing a second device layout 852 that the user device 400 may display to the user, in addition or alternatively to the device layout 851, in response to the user device 400 being communicatively coupled with the vehicle control system 210. The device layout 852 includes inter alia elements grouped into zones 881 to 884 and which correspond to vehicle information and/or vehicle functions controllable via the user device 400. For example, the zone 881 includes elements corresponding to hidden tabs, the zone 882 includes elements corresponding to at least some primary vehicle information, the zone 883 includes elements corresponding to menu items accessible by the user, the zone 884 includes elements corresponding to other vehicle functions. It is contemplated that a given element in one or more zones may be displayed over a background. It is also contemplated that the given element may change its state (e.g., color, position, etc.) in response to a user input.

In at least some embodiments of the present technology, a given device layout shown to the user may include elements corresponding to vehicle functions uniquely controllable via the user device 400. For example, the user interface of the vehicle 100 may not include an interface for HVAC controls, however, the HVAC controls may be uniquely controllable via the user device 400. Therefore, it can be said that a given vehicle function may be uniquely controllable in response to receiving user input from the user device 400, and not controllable via any other user interface of the vehicle 100.

It is contemplated that in at least some embodiments, in response to the user device 400 being communicatively coupled with the vehicle control system 210, the vehicle screen 420 may maintain display of the first layout 910 seen in FIG. 9A.

In other embodiments however, in response to the vehicle control system 210 having been communicatively coupled to the user device 400, the vehicle control system 210 may trigger display of a second layout 910′, as shown in a screenshot 900′ of FIG. 9B. The second layout 910′ includes the element 901, excludes the element 907 of the first layout 910, and includes modified elements 902′ to 906′. For example, the element 907 may correspond to vehicle information and/or vehicle function that is now displayed on the device layout 851 and/or the second device layout 852 via the device screen 420, instead of the vehicle screen 504. The modified elements 902′ to 906′ may correspond to vehicle information and/or vehicle functions of the elements 902 to 906, but in a different arrangement to the arrangement of the elements 902 to 906 of the first layout 910 due to the additional visual real-estate provided by the absence of the element 907.

In other embodiments however, in response to the vehicle control system 210 having been communicatively coupled to the user device 400, the vehicle control system 210 may trigger display of an other layout 910″, shown in a screenshot 900″ of FIG. 9C. The other layout 910″ includes the element 901′, excludes the element 907 of the first layout 910, and comprises other modified elements 902″ to 906″. For example, the element 907 may correspond to vehicle information and/or vehicle function that is now displayed on the device layout 851 via the device screen 420, instead of the vehicle screen 504. The modified elements 902″ to 906″ may correspond to vehicle information and/or vehicle functions of the elements 902 to 906, but in a different arrangement and size to the arrangement and size of the elements 902 to 906 of the first layout 910 due to the additional visual real-estate provided by the absence of the element 907.

In some embodiments, in response to the vehicle control system 210 having been communicatively coupled to the user device 400, a given layout on the vehicle screen 504 and a given layout on the device screen 410 may include elements corresponding to a same vehicle information and/or same vehicle function. In other words, such access to vehicle information and/or vehicle functions may be duplicated and now be accessible via at least one of the device screen 420 and the vehicle screen 504.

In other embodiments, in response to the vehicle control system 210 having been communicatively coupled to the user device 400, a given layout on the vehicle screen 504 and a given layout on the device screen 410 may include elements corresponding to mutually exclusive vehicle information and/or mutually exclusive vehicle functions. In other words, such access to vehicle information and/or vehicle functions may be accessible via only one of the device screen 420 and the vehicle screen 504.

As previously mentioned, the vehicle control system 210 may be configured to receive an indication of a user input via the communication link with the user device 400. For example, the user may interact with one or more elements to control one or more corresponding vehicle functions of the vehicle 100. In response to receiving the indication, the vehicle control system 210 may be configured to control the one or more corresponding vehicle functions in accordance with the user input. Additionally or alternatively, when the user device 400 is communicatively uncoupled from the vehicle control system 210, the vehicle control system 210 may be configured to display the first layout 910 on the vehicle screen 504.

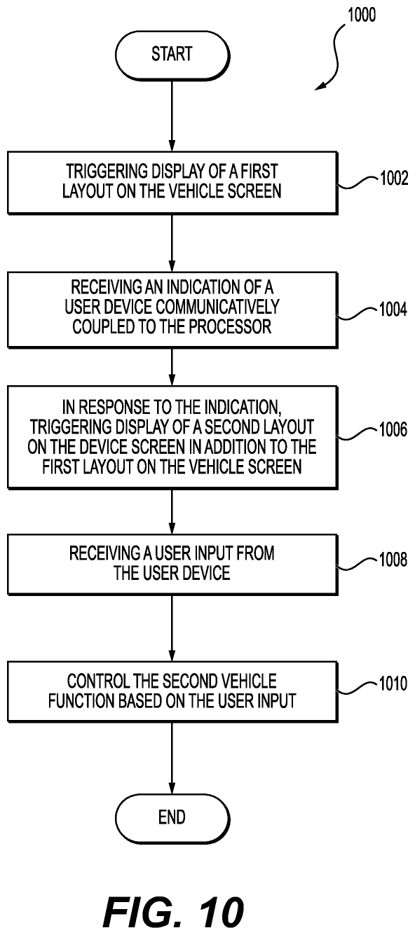

With reference to FIG. 10, there is depicted a scheme-block representation of a method 1000 executable by the processor 304 of the vehicle 100 in at least some embodiments of the present technology. It should be noted that computer-implemented methods with less steps and/or additional steps to those non-exhaustively listed below may be executed by the processor 304 of the vehicle 100, without departing from the scope of the present technology.
STEP 1002: triggering display of a first layout on the vehicle screen

The method 1000 begins at step 1002 with the processor 304 being configured to trigger display of a first layout on a vehicle screen. The first layout includes a first element indicative of a first vehicle function. For example, with reference to FIG. 9A, the processor 304 may be configured to display the first layout 910 on the vehicle screen 504. In this example, the first layout 910 includes the element 907 corresponding to a given vehicle function.
STEP 1004: receiving an indication of a user device communicatively coupled to the processor

The method 1000 continues to step 1004 with the processor 304 configured to receive an indication of that the user device 400 is communicatively coupled to the processor 304. In one example, the user device 400 may be communicatively coupled with the processor 304 via a wired communication link. In another example, the user device 400 may be communicatively coupled with the processor 304 via a wireless communication link.
STEP 1006: in response to the indication, triggering display of a second layout on the device screen in addition to the first layout on the vehicle screen

The method 1000 continues to step 1006 with the processor 304 configured to, in response to the indication, trigger display of a second layout on the on the device screen 420 in addition to the first layout on the vehicle screen 504. The second layout may include a second element indicative of a second vehicle function. For example, the processor 304 may be configured to display the device layout 851 and/or device layout 852 on the device screen 420 in addition to the first layout 910 on the vehicle screen 504.

In some embodiments, both the first layout displayed on a vehicle screen and on a device screen may include elements corresponding to a same vehicle function.

In other embodiments, in response to the indication, the processor 304 may be configured to trigger display of a third layout on the vehicle screen instead of the first layout. The third layout including the first element and excluding a third element. For example, the processor may be configured to trigger display of the layout 910′ and/or the layout 910″ on the vehicle screen 504. In this example, the newly-displayed layout excludes the element 907 from the first layout 910. It is contemplated that a device layout on the device screen 420 may include an element corresponding to the vehicle function of the so-excluded element 907.
STEP 1008: receiving a user input from the user device

The method 1000 continues to step 1008 with the processor 304 configured to receive a user input from the user device 400. For example, the user may interact with a given element on a current layout displayed on the device screen 420, and the user device 400 may capture this user input and transmit an indication thereof to the processor 304 via the communication link.
STEP 1010: control the second vehicle function based on the user input

The method 1000 continues to step 1010 with the processor 304 configured to control the second vehicle function based on the user input. For example, the processor 304 may be configured to receive a user input associated with a given vehicle function (corresponding to the vehicle function of the element with which the user interacted), and control the vehicle function accordingly.

In at least some embodiments, the processor 304 may be configured to receive an indication of a plurality of vehicle functions that the user of the vehicle 110 can control, including a first and a second vehicle function. The processor 304 may use the plurality of vehicle functions for generating the first layout 910 and/or the second layout 910′ and/or the third layout 910″, and the device layout 852 and/or device layout 853.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

The vehicle 100 implemented in accordance with at least some non-limiting embodiments of the present technology can be represented as follows, presented in numbered clauses.

CLAUSE 1. A vehicle comprising:
a frame;
a vehicle body formed at least in part by the frame;
a passenger compartment defined at least in part by the vehicle body;
a motor supported by the frame;
a plurality of wheels rotatively connected to the frame, the plurality of wheels being operatively connected to the motor;
at least one seat disposed in the passenger compartment;
a vehicle screen disposed in the passenger compartment;
a mounting bracket disposed in proximity to the vehicle screen, the mounting bracket being configured for holding a user device, the user device including a device screen; and
a vehicle control system communicatively coupled with the vehicle screen, the vehicle control system being configured to:
   trigger display of a first element on the vehicle screen indicative of a first vehicle function; and
   in response to being communicatively coupled with the user device, (i) trigger display of a second element on the device screen indicative of a second vehicle function and (ii) receive user input from the user device for controlling the second vehicle function.

CLAUSE 2. The vehicle of clause 1, wherein the mounting bracket is disposed in proximity to the vehicle screen so that the device screen is adjacent to the vehicle screen when the user device is held by the mounting bracket.

CLAUSE 3. The vehicle of any one of clauses 1 and 2, wherein the first vehicle function is different from the second vehicle function.

CLAUSE 4. The vehicle of any one of clauses 1 to 3, wherein the vehicle control system is further configured to trigger display of a third element on the vehicle screen indicative of the second vehicle function.

CLAUSE 5. The vehicle of clause 4, wherein, in response to being communicatively coupled to the user device, the vehicle control system is configured to:
trigger display of both the second element on the device screen and the third element on the vehicle screen.

CLAUSE 6. The vehicle of clause 4, wherein, in response to being communicatively coupled to the user device, the vehicle control system is configured to: trigger display of the second element on the device screen instead of displaying the third element on the vehicle screen.

CLAUSE 7. The vehicle of any one of clauses 1 to 6, wherein the vehicle control system is configured to trigger display of the second element and receive the user input during operation of the vehicle.

CLAUSE 8. The vehicle of any one of clauses 1 to 7, wherein the first vehicle function is a plurality of first vehicle functions comprising at least one of:
headlight angle;
seat heating;
steering wheel heating;
Heating Ventilation Air Conditioning (HVAC) control;
vehicle speed;
digital camera feed;
driving mode;
charge status;
charge time;
cruise control;
turn signal; and
tyre pressure.

CLAUSE 9. The vehicle of any one of clauses 1 to 8, wherein the second vehicle function is a plurality of second vehicle functions comprising at least one of:
seat heating;
steering wheel heating;
Heating Ventilation Air Conditioning (HVAC) control;
door locking;
door unlocking;
window defrosting;
navigation; and
media player.

CLAUSE 10. The vehicle of any one of clauses 1 to 9, wherein the user device is a smartphone.

CLAUSE 11. The vehicle of any one of clauses 1 to 9, wherein the user device is a tablet.

CLAUSE 12. The vehicle of any one of clauses 1 to 11, wherein the device screen includes a touch-screen configured to capture the user input.

CLAUSE 13. The vehicle of any one of clauses 1 to 12, wherein the vehicle control system is configured to communicatively couple with the user device by at least one of a wired connection and a wireless connection.

CLAUSE 14. A vehicle comprising: a frame;
a vehicle body formed at least in part by the frame;
a passenger compartment defined at least in part by the vehicle body;
a motor supported by the frame;
a plurality of wheels rotatively connected to the frame, the plurality of wheels being
operatively connected to the motor;
at least one seat disposed in the passenger compartment;
a user interface disposed in the passenger compartment, the user interface configured to receive a first user input;
a mounting bracket disposed in the passenger compartment, the mounting bracket being configured to hold a user device, the user device having a device screen; and
a vehicle control system configured to:
   in response to being communicatively coupled with the user device, trigger display of an element indicative of a vehicle function on the device screen and receive second user input for controlling the vehicle function from the user device,
      the vehicle function being uniquely controllable in response to receiving by
      the vehicle control system the second user input from the user device.

CLAUSE 15. The vehicle of clause 14, wherein the vehicle function is not controllable via the user interface.

CLAUSE 16. The vehicle of any one of clauses 14 and 15, wherein the vehicle function is a plurality of vehicle functions comprising at least one of:
seat heating;
steering wheel heating;
Heating Ventilation Air Conditioning (HVAC) control;
door locking;
door unlocking;
window defrosting;
navigation; and
media player.

CLAUSE 17. The vehicle of any one of clauses 14 to 16, wherein the vehicle control system is configured to trigger display of the element and receive the user input during operation of the vehicle.

CLAUSE 18. The vehicle of any one of clauses 14 to 17, wherein the user interface is a touch-screenless interface.

CLAUSE 19. The vehicle of any one of clauses 14 to 18, wherein the user interface comprises at least one of:
an acceleration pedal;
a brake pedal;
a steering wheel;
a headliner console;
a center console; and
a key fob.

A system implemented in accordance with at least some non-limiting embodiments of the present technology can be represented as follows, presented in numbered clauses.

CLAUSE 20. A system comprising:
a user device including a device screen; and
a vehicle including:
   a frame;
   a vehicle body formed at least in part by the frame;
   a passenger compartment defined at least in part by the vehicle body;
   a motor supported by the frame;
   a plurality of wheels rotatively connected to the frame, the plurality of wheels being operatively connected to the motor;
   at least one seat disposed in the passenger compartment;
   a vehicle screen disposed in the passenger compartment;
   a mounting bracket disposed in the passenger compartment in proximity to the vehicle screen, the mounting bracket being configured for holding the user device;
   a vehicle control system communicatively coupled with the vehicle screen and the user device, the vehicle control system being configured to:
      trigger display of a first element on the vehicle screen indicative of a first vehicle function;
      trigger display of a second element on the device screen indicative of a second vehicle function; and
      receive user input from the user device for controlling the second vehicle function.

CLAUSE 21. The system of clause 20, wherein the mounting bracket is disposed in proximity to the vehicle screen so that the device screen is adjacent to the vehicle screen when the user device is held by the mounting bracket.

CLAUSE 22. The system of any one of clauses 20 and 21, wherein the first vehicle function is different from the second vehicle function.

CLAUSE 23. The system of any one of clauses 20 to 22, wherein the vehicle control system is configured to: trigger display of a third element on the vehicle screen indicative of the second vehicle function in addition to the second element on the device screen.

CLAUSE 24. The system of any one of clauses 20 to 23, wherein the user device is a smartphone.

CLAUSE 25. The system of any one of clauses 20 to 23, wherein the user device is a tablet.

CLAUSE 26. The system of any one of clauses 20 to 25, wherein the device screen includes a touch-screen configured to capture the user input.

CLAUSE 27. The system of any one of clauses 20 to 26, wherein the vehicle is an electrically powered vehicle.

CLAUSE 28. A system comprising:
a user device including a device screen; and
a vehicle, including:
   a frame;
   a vehicle body formed at least in part by the frame;
   a passenger compartment defined at least in part by the vehicle body;
   a motor supported by the frame;
   a plurality of wheels rotatively connected to the frame, the plurality of wheels being operatively connected to the motor;
   at least one seat disposed in the passenger compartment;
   a user interface disposed in the passenger compartment, the user interface configured to receive a first user input;
   a mounting bracket disposed in the passenger compartment, the mounting bracket being configured to hold the user device;
   a vehicle control system configured to:
      trigger display of an element indicative of a vehicle function on the device screen and receive second user input for controlling the vehicle function from the user device,
         the vehicle function being uniquely controllable in response to receiving by the vehicle control system the second user input from the user device.

CLAUSE 29. The system of clause 28, wherein the vehicle function is not controllable via the user interface.

CLAUSE 30. The system of any one of clauses 28 and 29, wherein the user device is a smartphone.

CLAUSE 31. The system of any one of clauses 28 and 29, wherein the user device is a tablet.

CLAUSE 32. The system of any one of clauses 28 to 31, wherein the device screen includes a touch-screen configured to capture the user input.

CLAUSE 33. The system of any one of clauses 28 to 32, wherein the vehicle is an electrically powered vehicle.

CLAUSE 34. The system of any one of clauses 28 to 33, wherein the user interface is a touch-screenless interface.

CLAUSE 35. The system of any one of clauses 28 to 34, wherein the user interface comprises at least one of:
an acceleration pedal;
a brake pedal;
a steering wheel;
a headliner console;
a center console; and
a key fob.

The method 1000 implemented in accordance with at least some non-limiting embodiments of the present technology can be represented as follows, presented in numbered clauses.

CLAUSE 36. A computer-implemented method for controlling a vehicle, the vehicle comprising a vehicle screen and a processor communicatively coupled to the vehicle screen, the method being executable by the processor, the method comprising:
triggering display of a first layout on the vehicle screen, the first layout including a first element indicative of a first vehicle function;
receiving an indication of a user device communicatively coupled to the processor, the user device including a device screen;
in response to the indication, triggering display of a second layout on the device screen in addition to the first layout on the vehicle screen, the second layout including a second element indicative of a second vehicle function;
receiving a user input from the user device; and
control the second vehicle function based on the user input.

CLAUSE 37. The method of clause 36, wherein the first layout further includes a third element indicative of the second vehicle function.

CLAUSE 38. The method of clause 37, wherein the method further comprises:
in response to the indication, triggering display of a third layout on the vehicle screen instead of the first layout, the third layout including the first element and excluding the third element.

CLAUSE 39. The method of any one of clauses 36 to 38, wherein the method further comprises:
receiving an other indication of a plurality of vehicle functions controllable by the user of the vehicle, the plurality of vehicle functions include the first vehicle function and the second vehicle function;
generating the first layout using the plurality of vehicle functions; and
in response to the indication, generating the second layout using a set of vehicle functions from the plurality of vehicle functions and including the second vehicle function.

1. A vehicle comprising:
a frame;
a vehicle body formed at least in part by the frame;
a passenger compartment defined at least in part by the vehicle body;
a motor supported by the frame;
a plurality of wheels rotatively connected to the frame, the plurality of wheels being operatively connected to the motor;
at least one seat disposed in the passenger compartment;
a vehicle screen disposed in the passenger compartment;
a mounting bracket disposed in proximity to the vehicle screen, the mounting bracket being configured for holding a user device, the user device including a device screen; and
a vehicle control system communicatively coupled with the vehicle screen, the vehicle control system being configured to:
trigger display of a first element on the vehicle screen indicative of a first vehicle function; and
in response to being communicatively coupled with the user device, (i) trigger display of a second element on the device screen indicative of a second vehicle function and (ii) receive user input from the user device for controlling the second vehicle function.

2. The vehicle of claim 1, wherein the mounting bracket is disposed in proximity to the vehicle screen so that the device screen is adjacent to the vehicle screen when the user device is held by the mounting bracket.

3. The vehicle of claim 1, wherein the first vehicle function is different from the second vehicle function.

4. The vehicle of claim 1, wherein the vehicle control system is further configured to trigger display of a third element on the vehicle screen indicative of the second vehicle function.

5. The vehicle of claim 4, wherein, in response to being communicatively coupled to the user device, the vehicle control system is configured to:
trigger display of both the second element on the device screen and the third element on the vehicle screen.

6. The vehicle of claim 4, wherein, in response to being communicatively coupled to the user device, the vehicle control system is configured to:
trigger display of the second element on the device screen instead of displaying the third element on the vehicle screen.

7. The vehicle of claim 1, wherein the vehicle control system is configured to trigger display of the second element and receive the user input during operation of the vehicle.

8. The vehicle of claim 1, wherein the first vehicle function is a plurality of first vehicle functions comprising at least one of:
headlight angle;
seat heating;
steering wheel heating;
Heating Ventilation Air Conditioning (HVAC) control;
vehicle speed;
digital camera feed;
driving mode;
charge status;
charge time;
cruise control;
turn signal; and
tyre pressure.

9. The vehicle of claim 1, wherein the second vehicle function is a plurality of second vehicle functions comprising at least one of:
seat heating;
steering wheel heating;
Heating Ventilation Air Conditioning (HVAC) control;
door locking;
door unlocking;
window defrosting;
navigation; and
media player.

10.-12. (canceled)

13. The vehicle of claim 1, wherein the vehicle control system is configured to communicatively couple with the user device by at least one of a wired connection and a wireless connection.

14. A vehicle comprising:
a frame;
a vehicle body formed at least in part by the frame;
a passenger compartment defined at least in part by the vehicle body;
a motor supported by the frame;
a plurality of wheels rotatively connected to the frame, the plurality of wheels being operatively connected to the motor;
at least one seat disposed in the passenger compartment;
a user interface disposed in the passenger compartment, the user interface configured to receive a first user input;
a mounting bracket disposed in the passenger compartment, the mounting bracket being configured to hold a user device, the user device having a device screen; and
a vehicle control system configured to:
in response to being communicatively coupled with the user device, trigger display of an element indicative of a vehicle function on the device screen and receive second user input for controlling the vehicle function from the user device,
the vehicle function being uniquely controllable in response to receiving by the vehicle control system the second user input from the user device.

15. The vehicle of claim 14, wherein the vehicle function is not controllable via the user interface.

16. The vehicle of claim 14, wherein the vehicle function is a plurality of vehicle functions comprising at least one of:
seat heating;
steering wheel heating;
Heating Ventilation Air Conditioning (HVAC) control;
door locking;
door unlocking;
window defrosting;
navigation; and
media player.

17. The vehicle of claim 14, wherein the vehicle control system is configured to trigger display of the element and receive the user input during operation of the vehicle.

18. The vehicle of claim 14, wherein the user interface is a touch-screenless interface.

19. The vehicle of claim 14, wherein the user interface comprises at least one of:
an acceleration pedal;
a brake pedal;
a steering wheel;
a headliner console;
a center console; and
a key fob.

20.-35. (canceled)

36. A computer-implemented method for controlling a vehicle, the vehicle comprising a vehicle screen and a processor communicatively coupled to the vehicle screen, the method being executable by the processor, the method comprising:
triggering display of a first layout on the vehicle screen, the first layout including a first element indicative of a first vehicle function;
receiving an indication of a user device communicatively coupled to the processor, the user device including a device screen;
in response to the indication, triggering display of a second layout on the device screen in addition to the first layout on the vehicle screen, the second layout including a second element indicative of a second vehicle function;
receiving a user input from the user device; and
control the second vehicle function based on the user input.

37. The method of claim 36, wherein the first layout further includes a third element indicative of the second vehicle function.

38. The method of claim 37, wherein the method further comprises:
in response to the indication, triggering display of a third layout on the vehicle screen instead of the first layout, the third layout including the first element and excluding the third element.

39. The method of claim 36, wherein the method further comprises:
receiving an other indication of a plurality of vehicle functions controllable by the user of the vehicle, the plurality of vehicle functions include the first vehicle function and the second vehicle function;
generating the first layout using the plurality of vehicle functions; and
in response to the indication, generating the second layout using a set of vehicle functions from the plurality of vehicle functions and including the second vehicle function.
